(19) United States
(12) Patent Application Publication
(10) Pub. No.: US 2013/0167093 A1
(43) Pub. Date: Jun. 27, 2013

(54) DISPLAY APPARATUS FOR RELEASING LOCKED STATE AND METHOD THEREOF

(71) Applicants: Nipun KUMAR, Suwon-si (KR); Jung-joo Sohn, Seoul (KR); Ji-Yeon Kwak, Seoul (KR)

(72) Inventors: Nipun KUMAR, Suwon-si (KR); Jung-joo Sohn, Seoul (KR); Ji-Yeon Kwak, Seoul (KR)

(73) Assignee: Samsung Electronics Co., Ltd., Suwon-si (KR)

(21) Appl. No.: 13/590,773

(22) Filed: Aug. 21, 2012

(30) Foreign Application Priority Data
Dec. 23, 2011 (KR) 10-2011-0141803

(51) Int. Cl. G06F 3/033

(52) U.S. Cl. 715/863

(57) ABSTRACT

A method and apparatus are provided for releasing a locked state of a display apparatus. A display unit displays a locked view having a line and an affordance object connected to the line. When a user touches a point on the line in the locked view, a control unit controls the display unit to switch to an unlocked view while separating the affordance object by cutting the line at the point on the line.

### PRIORITY

This application claims priority under 35 U.S.C. §119(a) to Korean Patent Application No. 2011-0141803, filed on Dec. 23, 2011 in the Korean Intellectual Property Office, the entire disclosure of which is incorporated herein by reference.

### BACKGROUND OF THE INVENTION

1. Field of the Invention

The present invention relates generally to a display apparatus, and more particularly, to a display apparatus for releasing a locked state using an affordance object displayed in a locked view, and a method for releasing the locked state.

2. Description of the Related Art

Various display devices have been developed in accordance with the advances in electronic technology. Recently, the use of display devices, such as, for example, smart phones or tablet Personal Computers (PCs), which support various applications is rapidly increasing.

A display device may include a large touch screen, which allows a user to more easily control the manipulation of the display device while viewing contents. However, when using the large touch screen, the screen of the display device may be touched to execute a function even when it is not the user's intention.

To avoid this, the display device can include a locking function. When the screen is touched or a key is selected while in a locked state, no function is performed. The user can release the locked state with a preset manipulation.

The user manipulation for releasing the locked state can be defined by a display device manufacturer. For example, the manufacturer can design to release the locked state only through a predefined manipulation within a fixed part on the screen.

However, when the fixed manipulation is continuously performed in the fixed part of the screen, pixels of the corresponding part or touch sensors under the screen are repeatedly used, thereby degrading the sensing performance.

Further, the fixed or predefined manipulation does not meet user's needs for a more dynamic and interesting User Interface (UI).

### SUMMARY OF THE INVENTION

The present invention has been made to address at least the above problems and/or disadvantages and to provide at least the advantages described below. Accordingly, an aspect of the present invention provides a display apparatus that allows a user to easily and intuitively release a locked state using an affordance object, and a method for releasing the locked state.

According to an aspect of the present invention, a display apparatus is provided that includes a display unit for displaying a locked view including a line and an affordance object connected to the line. The display apparatus also includes a control unit for, when a user touches a point on the line in the locked view, controlling the display unit to switch to an unlocked view while separating the affordance object by cutting the line at the point on the line.

An individual function may be mapped the affordance object. When a user touch cuts the line, the control unit may release the lock and executes the individual function corresponding to the affordance object connected to the cut line.

The unlocked view may be an execution view of the function corresponding to the affordance object connected to the cut line.

The control unit may change a length of the line according to a state of the function mapped to the affordance object.

The display apparatus may further include a storage unit for storing information of a plurality of affordance object types. The control unit may randomly determine and change the type of the affordance object in every locked view display.

The display apparatus may further include a communication unit for receiving a call connection request. When the call connection request is received, the control unit may control the display unit to display a call reception view comprising a first affordance object mapped to a call rejection function and a second affordance object mapped to a call connection function, and execute the call rejection function or the call connection function of the first or second affordance object corresponding to the cut line.

The call reception view may include an information display region that displays caller information.

A plurality of lines and affordance objects may be displayed and connected, and the control unit may switch to the unlocked view when all of the plurality of lines are cut.

The affordance object may be one of a balloon, a marble, and an icicle.

According to another aspect of the present invention, a method is provided for releasing a locked state of a display apparatus. A locked view, including a line and an affordance object connected to the line, is displayed on a display unit. When a user touches a point on the line in the locked view, the display apparatus switches to an unlocked view while separating the affordance object by cutting the line at a point on the line.

A plurality of lines and affordance objects may be displayed and connected and a different function is mapped to each of the plurality of affordance objects. The method may further include when one of the plurality of lines is cut, executing a function of a corresponding affordance object connected to the cut line.

The unlocked view is an execution view of the function of the corresponding affordance object connected to the cut line.

A plurality of lines and affordance objects are displayed and connected, and a length of each line is individually determined according to a state of a corresponding function mapped to a connected affordance object.

A type of the affordance object may be randomly changed in every locked view display.

The method may further include receiving a call connection request; when the call connection request is received, displaying a call reception view comprising a first affordance object mapped to a call rejection function and a second affordance object mapped to a call connection function; and executing the call rejection function or the call connection function of the first or second affordance object corresponding to the cut line.

The call reception view may include an information display region that displays caller information.

A plurality of lines and affordance objects may be displayed and connected, and the unlocked view may be displayed when all of the plurality of lines are cut.

The affordance object may be one of a balloon, a marble, and an icicle.

As set forth above, the user can easily release the lock using the affordance object. Hence, the concentrated use of a particular part of the screen can be prevented and the user's satisfaction can be increased.

### BRIEF DESCRIPTION OF THE DRAWINGS

The above and other aspects, features and advantages of the present invention will be more apparent from the following description, when taken in conjunction with the accompanying drawings, in which:

FIG. 1 is a block diagram illustrating a display apparatus, according to an embodiment of the present invention;

FIGS. 2 through 5 are diagrams illustrating various unlocking methods in the display apparatus, according to embodiments of the present invention;

FIG. 6 is a block diagram illustrating a display apparatus, according to another embodiment of the present invention;

FIGS. 7 and 8 are diagrams illustrating affordance object display change when a call connection request is received, according to an embodiment of the present invention;

FIGS. 9 through 13 are diagrams illustrating various user manipulations, according to embodiments of the present invention;

FIG. 14 is a flowchart illustrating an unlocking method, according to an embodiment of the present invention; and

FIG. 15 is a flowchart illustrating an unlocking method, according to another embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

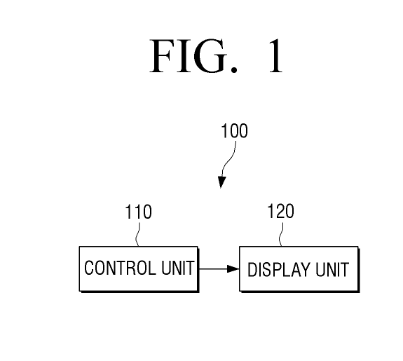

FIG. 1 is a block diagram illustrating a display apparatus, according to an embodiment of the present invention. Referring to FIG. 1, a display apparatus 100 includes a control unit 110 and a display unit 120.

The control unit 110 controls operations of the display apparatus 100. The control unit 110 can control hardware of the display apparatus 100 and support various functions by executing an Operating System (O/S) or various applications stored to a memory of the display apparatus 100.

When the display apparatus 100 is turned on or reset, when the ongoing function of the display apparatus 100 is completed, or when there is no user manipulation or no operation of the display apparatus 100 during a certain time, the control unit 110 operates in a locked state. In the locked state, the control unit 110 controls the display unit 120 to display a locked view.

The display unit 120 displays the locked view including an affordance object. The affordance object is an object generated to induce the user manipulation. Specifically, the affordance object can be represented as various images connected to a line. The line indicates a long shape over a certain length, such as string or rope. The affordance object may be displayed as integrated with the line, such as icicle.

When the line part connected to the affordance object is touched in the locked view, the control unit 110 controls the display unit 120 to switch to an unlocked view while cutting the line in response to the touch, and separating the affordance object.

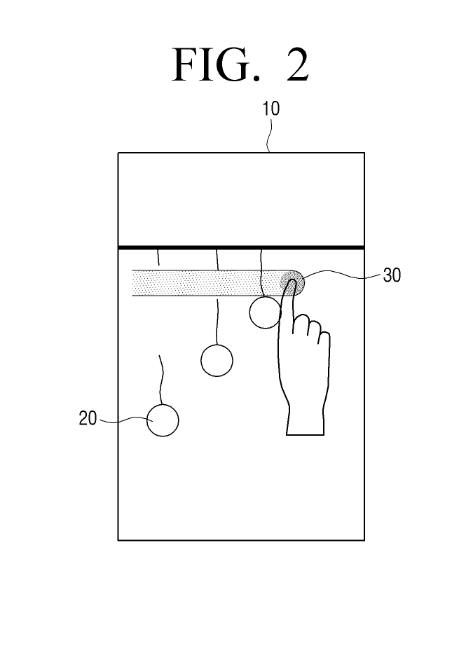

FIG. 2 illustrates an affordance object, according to an embodiment of the present invention. Referring to FIG. 2, a locked view 10 displays a plurality of affordances objects 20 connected to a plurality of lines, respectively. In FIG. 2, the line is represented as a string and the affordance object 20 is represented as a marble, for example.

When the user touches a line, the control unit 110 can control the display unit 120 to switch to an unlocked view while displaying that the line is cut and the respective affordance object 20 drops. The user can touch the display unit in various manners such as by dragging, rubbing, long pressing, flicking, and tapping. The user applies a dragging motion in FIG. 2. Hence, a part of the line contacting a user drag trace or dragging motion 30 is cut.

When the user drags through the affordance object 20, and not a part of the line, the control unit 110 can control the display unit 120 to display that the affordance object 20 is shaken by the user's touch, by the line is not cut. In this case, the locked state may not be released.

When the plurality of lines and affordance objects 20 is displayed as shown in FIG. 2, the control unit 110 can control the display unit 120 to switch to the unlocked view when all of the lines are cut.

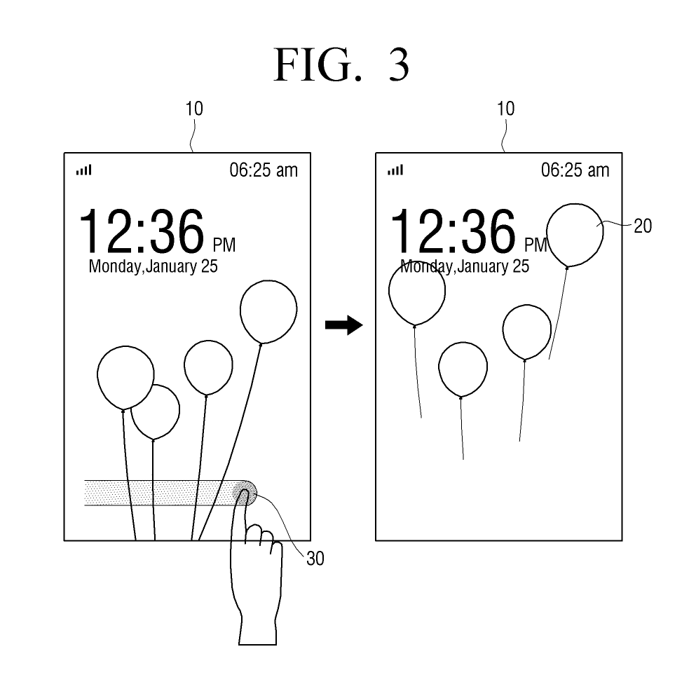

FIG. 3 illustrates another affordance object, according to an embodiment of the present invention. Referring to FIG. 3, the affordance objects 20 displayed in the locked view 10 are represented as balloons on a string. The user can cut the string by performing a dragging motion 30 through the string. The control unit 110 controls the display unit 120 to switch to the unlocked view as the balloons on the cut strings rise into the sky.

The locked view 10 can display basic information such as time, date and weather, in addition to the affordance objects, as shown in FIG. 3. The basic information can be displayed at locations in the locked view 10 that do not overlap the affordance objects.

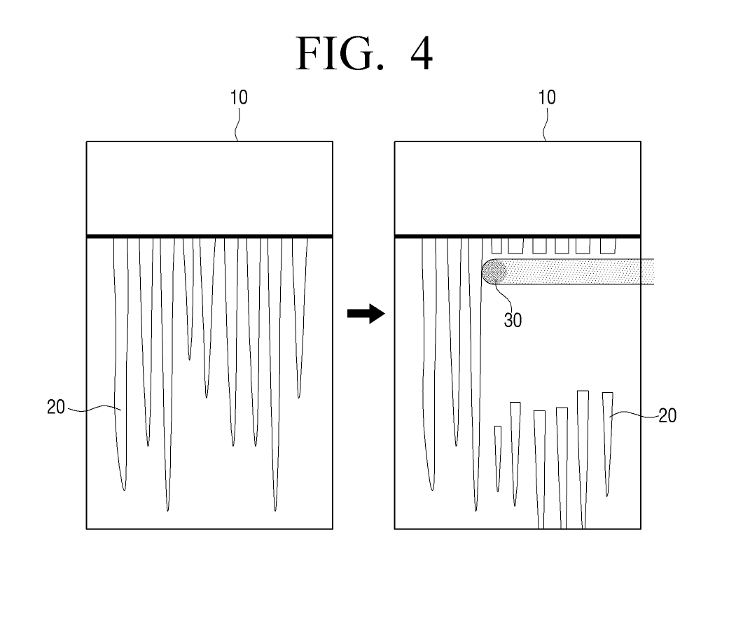

FIG. 4 depicts yet another affordance object, according to an embodiment of the present invention. Referring to FIG. 4, the locked view 10 displays the affordance objects 20 in long shapes, such as icicles.

The user can cut the icicles by performing a dragging motion 30 across the icicles. The control unit 110 controls the display unit 120 to display the unlocked view while displaying that the icicle is cut when the dragging motion 30 is applied. Other images, such as flowers, grass, reeds, and trees, which are similar to the icicle, can also be used as the affordance objects. Specifically, when the user touches such images, the corresponding images may be cut and the view may be switched to the unlocked view.

Functions can be mapped to the plurality of the affordance objects respectively. When all of the affordance objects are cut, the view is switched to the unlocked view. When only one affordance object is cut, an execution view of the function mapped to that affordance object can be displayed immediately.

When an individual function is mapped to each affordance object, the control unit 110 can change the line length according to a status of the function mapped to the affordance object connected to the corresponding line. The status of the function can be a frequency of use, update state, and recent use. For example, the control unit 110 can lengthen the line connected to the affordance object mapped to the function frequently used, and relatively shorten the line connected to the affordance object mapped to the function less frequently used. The control unit 110 can lengthen the line connected to the updated affordance object, and further lengthen the line when the update degree is considerable.

The shape or the color of each affordance object can vary. In an embodiment of the present invention, the shape or the color can be changed according to the state of the function.

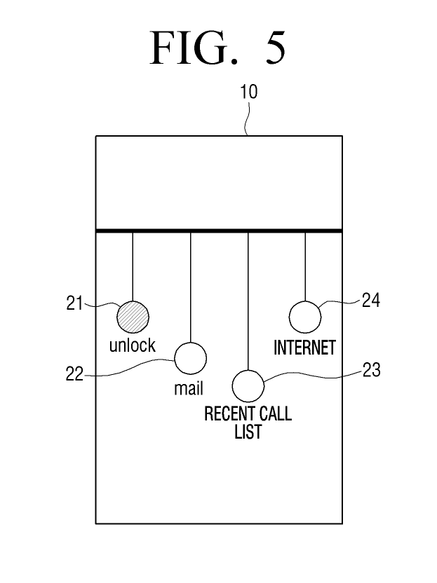

FIG. 5 illustrates still another affordance object, according to an embodiment of the present invention. Referring to FIG. 5, the locked view 10 displays a plurality of affordance objects 21 through 24, and functions are mapped to the affordance objects 21 through 24, respectively.

When the user touches the display unit at the string of one affordance object, the control unit 110 cuts the corresponding string, separates the affordance object, and immediately executes the function corresponding to the separated affordance object. In FIG. 5, the affordance objects 21 through 24 are mapped to an unlocking function, a message reception function, a recent call list check function, and an Internet connection function. In FIG. 5, the functions mapped to the affordance objects 21 through 24 may be default functions defined by a manufacturer of the display apparatus, favorite functions frequently used by the user, or the functions set to display in the locked view according to the user.

As described above, the affordance objects can be implemented in various shapes. The affordance objects can be represented by other images, which can be cut by the user's touch. Hence, the user can find interest in the unlocking process, and thus satisfaction is maximized.

The unlocked view displayed after the affordance object is changed can be implemented in various shapes according to embodiments of the present invention. For example, the unlocked view can be an execution view generated by the execution of a particular application. When the lock is released, the execution view of an application used before the display apparatus enters the locked state, a default application, or an application frequently used can be displayed immediately. When the line connected to one affordance object is cut as shown in FIG. 5, the execution view of the function corresponding to the affordance object may be used as the unlocked view.

For example, the unlocked view can use a view including an icon display region for arranging applications, widgets, folder icons, and menus installed to the display apparatus, and a fixed menu region. The fixed menu region displays menus of functions frequently used by the user, such as call, message, Internet, and recent call list, or default functions.

Such an unlocked view can be automatically displayed after the affordance object is cut.

As described above, the affordance object includes a variety of objects, which can be displayed as if they are cut by the user's touch. The affordance object itself can induce the user's touch. A text or an indicator image may be displayed beside the affordance object to notify the user that the corresponding affordance object needs to be touched to release the lock. Alternatively, the affordance object can be displayed to periodically shake or flicker so that the user may intuitively know that he/she needs to touch it.

The display apparatus can be implemented using various devices including a TV, a table PC, a PC, a notebook PC, a digital frame, an e-book, a PDA, and a mobile phone. A display apparatus having the communication capability, such as mobile phone, can receive a call in the locked state. In this case, the affordance object can be changed to determine whether to receive or reject the call in the locked view.

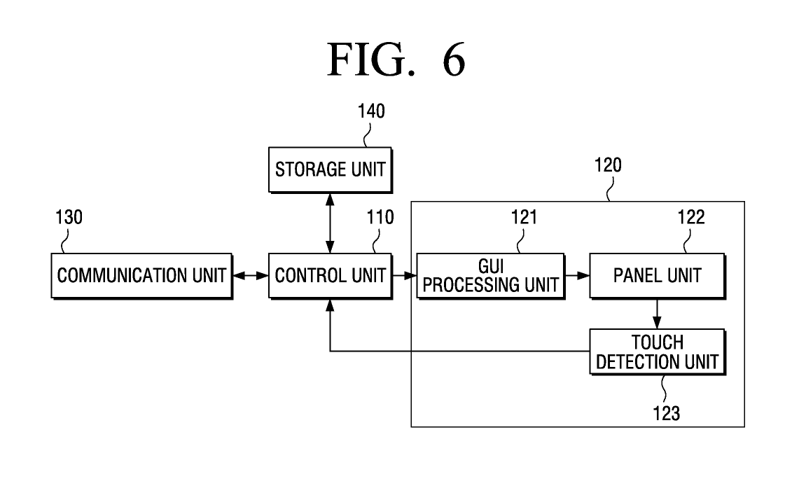

FIG. 6 is a block diagram illustrating a display apparatus according to another embodiment of the present invention. Referring to FIG. 6, the display apparatus includes the control unit 110, the display unit 120, a communication unit 130, and a storage unit 140.

The display unit 120 includes a Graphical User Interface (GUI) processing unit 121, a panel unit 122, and a touch detection unit 123. Using setup information stored to the storage unit 140, the GUI processing unit 121 generates screen configuration data of various types, such as the locked view, the unlocked view, and an application execution view. Based on the screen configuration data generated by the GUI processing unit 121, the panel unit 122 displays the view by driving hardware including a Liquid Crystal Display (LCD) panel and a backlight unit. The touch detection unit 123 provides coordinates of the user's touch point to the control unit 110, using a touch sensor equipped in the panel unit 122.

The control unit 110 controls the GUI processing unit 121 and the panel unit 122 to output the view corresponding to the current state of the display apparatus. Using the coordinates provided from the touch detection unit 123, the control unit 110 calculates the user's touch point, touch trace, and movement speed. Based on the calculation results, the control unit 110 determines whether to change the affordance object.

The storage unit 140 stores the O/S, applications, widget programs, and data. The storage unit 140 can store information relating to at least one of various affordance objects as described above.

The control unit 110 can be driven by the O/S stored to the storage unit 140 to execute various applications or widget programs selected by the user and to carry out the function. When it is necessary to switch to the locked state, the control unit 110 enters the locked state so that the display apparatus does not respond to any key manipulation or any touch of the user. When the user arbitrarily manipulates the key or touches the screen in the locked state, the control unit 110 controls the display unit 120 to generate and display the locked view.

The communication unit 130 receives a call connection request over a telephone network. When the call is connected, the communication unit 130 converts the user's input voice to a voice signal, transmits the voice signal to the other telephone over the telephone network, converts a voice signal received from the other telephone, and provides the voice signal to a speaker.

When the affordance object is touched in the locked view, the control unit 110 controls the display unit 120 to display the unlocked view while representing that the line is cut according to the touch point and the affordance object is separated.

As described above, when the storage unit 140 stores various affordance objects, the control unit 110 may randomly determine the affordance object displayed in the locked view. Accordingly, the affordance object displayed in every locked view can differ at random.

In the locked state with the locked view displayed, when the call connection request is received through the communication unit 130, the control unit 110 can change the shape or number of the affordance objects so that the user can select whether to connect or reject the call.

When the call connection request is received through the communication unit 130 in the unlocked state, the control unit 110 can control the display unit 120 to also display the affordance objects so that the user can select whether to connect or reject the call.

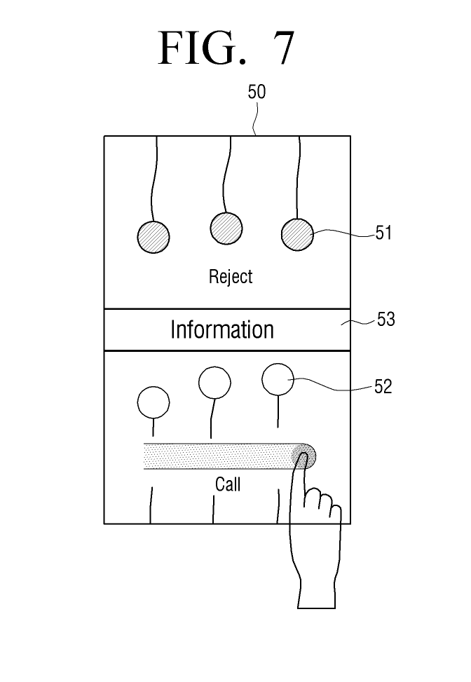

FIG. 7 illustrates the change of the locked view when the call connection request is received, according to an embodiment of the present invention. Referring to FIG. 7, when the call connection request is received while the locked view 10 including the affordance objects 20 of FIG. 2 are displayed, a call reception view 50 including a caller information region 53 and first and second affordance objects 51 and 52 is displayed.

The caller information region 53 displays information such as an image, a name, or a phone number of the caller. Using a caller number of the call connection request received at the communication unit 130, the control unit 110 can read various caller information stored to the storage unit 140. The read caller information is provided to the GUI processing unit 121 of the display unit 120. The GUI processing unit 121 generates data of the call reception view 50 including the caller information region 53 using the caller information. The generated data is provided to the panel unit 122 to display the call reception view 50.

In FIG. 7, the caller information region 53 is displayed at the center of the call reception view 50, the first group of one or more affordance objects 51 is displayed above the caller information region 53, and the second group of one or more affordance objects 52 is displayed below the caller information region 53. In FIG. 7, the first group of one or more affordance objects 51 and the second group of one or more affordance objects 52 are each represented as a plurality of marbles.

The first group of one or more affordance objects 51 is mapped to the call rejection function, and the second group of one or more affordance objects 52 is mapped to the call connection function. The user can execute his/her intended function by touching one of the two groups of affordance objects 51 and 52. In FIG. 7, the user touches the second group of one or more affordance objects 52 to connect the call. The control unit 110 can control the communication unit 130 to connect the call and control the display unit 120 to display a call connection view.

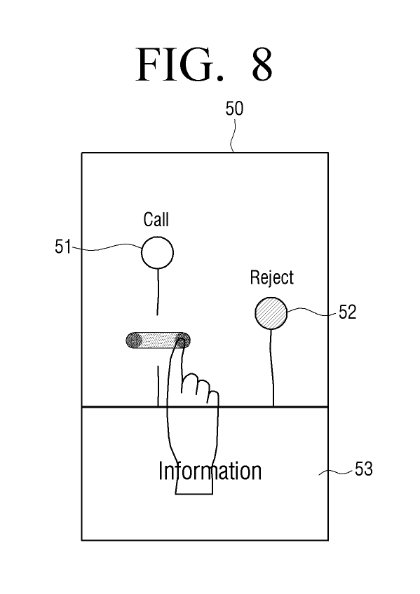

FIG. 8 depicts another change of the locked view when the call connection request is received, according to an embodiment of the present invention. Referring to FIG. 8, a call reception view 50 displays a caller information region 53 in the lower part and first and second affordance objects 51 and 52, each as a single image, in the upper part.

The call connection function and the call rejection function can be mapped to the first and second affordance objects 51 and 52, respectively. Which affordance object the call connection function is mapped to can vary according to the design, but is not limited to that which is provided in FIGS. 7 and 8.

While the affordance object having the same shape as in FIG. 2 is used as the first and second affordance objects in FIGS. 7 and 8, the first and second affordance objects can use an image different from the affordance object 20 displayed in the locked view 10.

Specifically, after the affordance object of FIG. 2 is displayed, the plurality of the affordance objects of one of FIGS. 3, 4 and 5 may be displayed, or different affordance objects on the function basis, may be displayed. For example, the call connection function can be mapped to the affordance object of FIG. 2 and the call rejection function can be mapped to the affordance object of FIG. 3.

The call connection request can be received outside of the locked state. In this case, the control unit 110 can control the display unit 120 to display the plurality of the affordance objects as described above, map the call connection function or the call rejection function to each affordance object, and conduct the corresponding function in response to the user touch.

There can be various operation modes in addition to the received call connection request, such as, for example, a mode for checking a text message or a mail received, a power-save mode due to the lack of the remaining battery capacity, and a mode for outputting an alarm signal when an alarm set time arrives. The control unit 110 can enter various operation modes, such as a mail check mode, a power-saving mode, and an alarm output mode.

In such operation modes, the control unit 110 can control the display unit 120 to display a plurality of affordance objects mapped to new functions selectable in the corresponding operation mode. For example, when a text message or a mail is received, the display unit 120 may display an affordance object mapped to the function for checking the text message or the mail received, together with an affordance object mapped to the function for checking caller information or postponing the text message or mail check.

When the alarm set time arrives and the alarm output mode for outputting the alarm signal is performed, the control unit 110 may display a plurality of affordance objects mapped to various functions, such as, for example, an affordance object mapped to an alarm stop function and an affordance object mapped to a function for resetting the alarm after 5 minutes.

In the power-save mode, a plurality of affordance objects mapped to a function for returning to the normal mode and a function for maintaining the power-save mode may be displayed. As such, the function of the affordance object can be variously set according to the situation.

The plurality of the affordance objects can be represented the same and the text explaining their mapping function can be displayed together.

According to an embodiment of the present invention, at least one of the shape, the size, and the color of the affordance objects can differ.

The number of the affordance objects mapped to the functions may be, not limited to the plural or the singular.

The user can immediately select his/her intended function by cutting line for the affordance object represented, according to embodiments of the present invention.

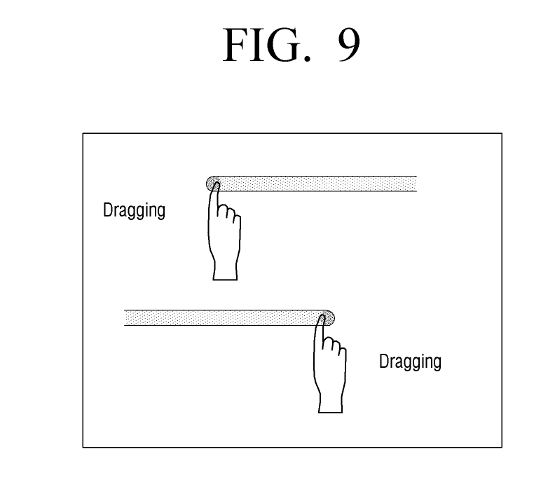

FIGS. 9 through 13 illustrate various user manipulations, according to embodiments of the present invention.

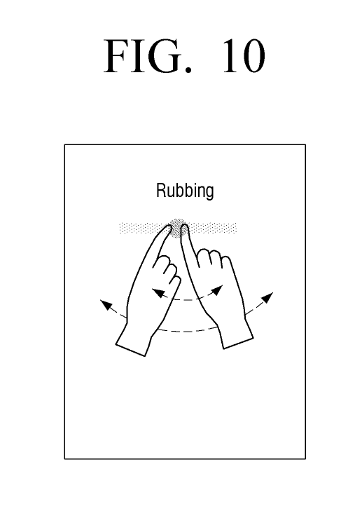

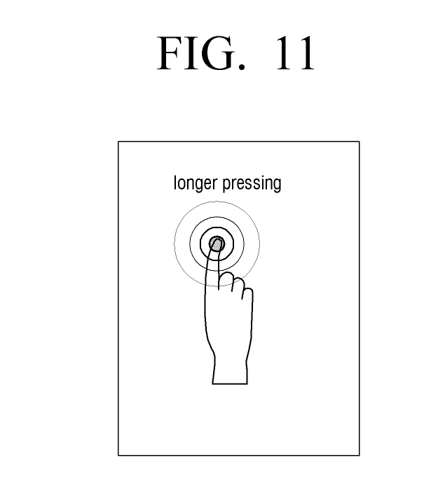

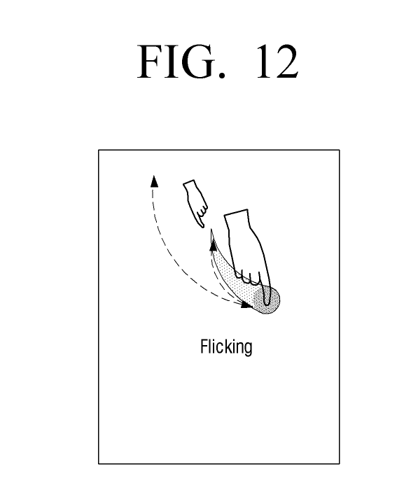

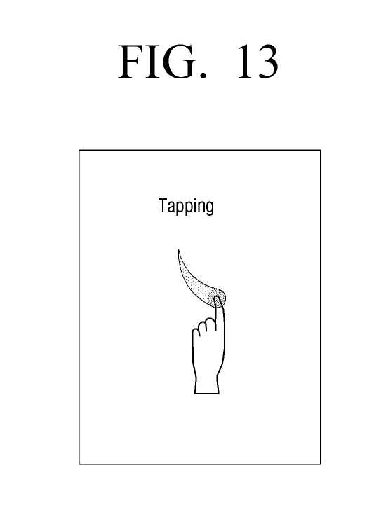

FIG. 9 illustrates a user drag operation, according to an embodiment of the present invention. The drag operation is performed by touching a point and moving to another point while still touching the display. FIG. 10 illustrates a user rubbing operation, according to an embodiment of the present invention. The rubbing operation is performed by touching a point and moving forward and backward. FIG. 11 illustrates a long pressing operation that presses a point over a threshold time, according to an embodiment of the present invention. FIG. 12 illustrates a flicking operation that touches a point and suddenly moves in one direction, according to an embodiment of the present invention. FIG. 13 illustrates a tapping operation in which a fingertip softly touches the display, according to an embodiment of the present invention. As such, the user can cut the affordance object by touching the screen in various manners. Specifically, when the user drags or flicks, the line within the trace can be cut. When the user rubs, presses long, or taps the line, the corresponding line can be cut.

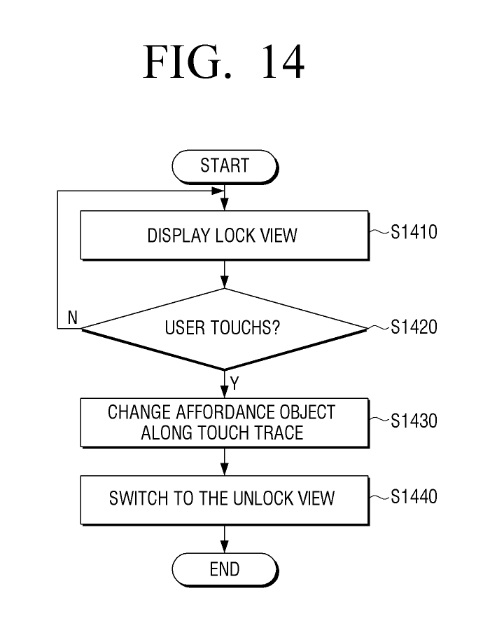

FIG. 14 is a flowchart illustrating an unlocking method, according to an embodiment of the present invention. Referring to FIG. 14, the display apparatus displays the locked view including the affordance object in the locked state, in step 51410. The affordance object is displayed as an image connected to the line or an image similar to the line. Specifically, the affordance object can be generated in various forms as shown in FIGS. 2 through 5.

In step S1420, the user touches the affordance object on the screen using a finger or a touch pen, for example. In response to the touch, the affordance object is changed to represent that the line is cut along the touch trace and the affordance object is detached from the line, in step S1430.

As the affordance object is changed, the unlocked view is displayed, in step S1440. The unlocked view can be realized in various forms as described above.

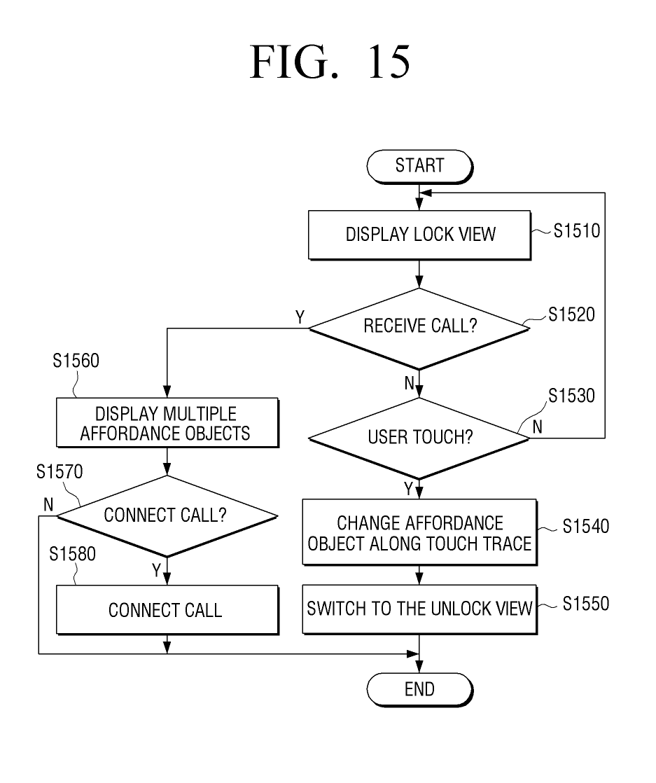

FIG. 15 is a flowchart illustrating an unlocking method, according to another embodiment of the present invention. Referring to FIG. 15, when the locked view is displayed in step S1510, it is determined whether a call is received, in step S1520. When the call is received, the plurality of affordance objects is displayed in the locked view, in step S1560. Each affordance object is mapped to a function. For example, the affordance object mapped to the call connection function and the affordance object mapped to the call rejection function can be displayed together as shown in FIGS. 7 and 8. The caller information can be displayed together with the affordance object.

The user determines whether to connect the call by touching the line of the affordance object mapped to the call connection function or the line of the affordance object mapped to the call rejection function, in step 51570. When the line of the affordance object mapped to the call connection is touched, the call is connected in step 51580 and the call connection view is displayed. By contrast, when the line of the other affordance object is touched, the call connection is rejected.

When no call is received and it is determined that the user touches the affordance object in step S1530, the display apparatus changes the affordance object to represent that the line is cut along the touch trace and the affordance object is detached, in step S1540, and switches to the unlocked view by releasing the locked state, in step S1550.

While the plurality of the affordance objects is displayed when the call is received in FIG. 15, various operation modes can be provided besides the call reception mode. Every time the display apparatus enters each operation mode, it can further display at least one affordance object mapped to the function of the corresponding operation mode.

When the call is received or the operation mode is changed outside of the locked state, at least one affordance object mapped to the function can be displayed.

The affordance object displayed in the locked view and the affordance object displayed when the call is received or other operation mode is switched can be realized in the same or a different form according to embodiments of the present invention.

As such, since the user releases the lock by touching a certain part of the affordance object, the fixed part is not repeatedly used to release the lock. Since the affordance object varies based on the random determination, the lock can be released by evenly touching the screen. Thus, partial degradation of the touch panel can be prevented, and the user can find interest in releasing the lock to thus maximize user satisfaction.

A program for executing the unlocking methods according to various embodiments of the present invention can be separately provided and recorded to a recording medium. An apparatus mounted with the recording medium can fulfill the unlocking methods by executing the corresponding program.

In detail, the program for executing the unlocking methods can be contained in various recording media readable by the terminal, such as Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

Although certain embodiments of the present invention have been shown and described, it will be understood by those skilled in the art that various changes in form and detail may be made therein without departing from the spirit and scope of the invention as defined by the appended claims and their equivalents.

What is claimed is:

1. A display apparatus comprising:
a display unit for displaying a locked view comprising a line and an affordance object connected to the line; and
a control unit for, when a user touches a point on the line in the locked view, controlling the display unit to switch to an unlocked view while separating the affordance object by cutting the line at the point on the line.

2. The display apparatus of claim 1, wherein an individual function is mapped the affordance object, and
when a user touch cuts the line, the control unit releases the lock and executes the individual function corresponding to the affordance object connected to the cut line.

3. The display apparatus of claim 2, wherein the unlocked view is an execution view of the function corresponding to the affordance object connected to the cut line.

4. The display apparatus of claim 1, wherein the control unit changes a length of the line according to a state of the function mapped to the affordance object.

5. The display apparatus of claim 1, further comprising:
a storage unit for storing information of a plurality of affordance object types,
wherein the control unit randomly determines and changes the type of the affordance object in every locked view display.

6. The display apparatus of claim 1, further comprising:
a communication unit for receiving a call connection request,
wherein, when the call connection request is received, the control unit controls the display unit to display a call reception view comprising a first affordance object mapped to a call rejection function and a second affordance object mapped to a call connection function, and executes the call rejection function or the call connection function of the first or second affordance object corresponding to the cut line.

7. The display apparatus of claim 6, wherein the call reception view comprises an information display region that displays caller information.

8. The display apparatus of claim 1, wherein a plurality of lines and affordance objects are displayed and connected, and
wherein the control unit switches to the unlocked view when all of the plurality of lines are cut.

9. The display apparatus of claim 1, wherein the affordance object is one of a balloon, a marble, and an icicle.

10. A method for releasing a locked state of a display apparatus, comprising the steps of displaying a locked view comprising a line and an affordance object connected to the line; and
when a user touches a point on the line in the locked view, switching to an unlocked view while separating the affordance object by cutting the line at the point on the line.

11. The method of claim 10, wherein a plurality of lines and affordance objects are displayed and connected and a different function is mapped to each of the plurality of affordance objects, and further comprising:
when one of the plurality of lines is cut, executing a function of a corresponding affordance object connected to the cut line.

12. The method of claim 11, wherein the unlocked view is an execution view of the function of the corresponding affordance object connected to the cut line.

13. The method of claim 10, wherein a plurality of lines and affordance objects are displayed and connected, and a length of each line is individually determined according to a state of a corresponding function mapped to a connected affordance object.

14. The method of claim 10, wherein a type of the affordance object is randomly changed in every locked view display.

15. The method of claim 10, further comprising:
receiving a call connection request;
when the call connection request is received, displaying a call reception view comprising a first affordance object mapped to a call rejection function and a second affordance object mapped to a call connection function; and
executing the call rejection function or the call connection function of the first or second affordance object corresponding to the cut line.

16. The method of claim 15, wherein the call reception view comprises an information display region that displays caller information.

17. The method of claim 10, wherein a plurality of lines and affordance objects are displayed and connected, and the unlocked view is displayed when all of the plurality of lines are cut.

18. The method of claim 10, wherein the affordance object is one of a balloon, a marble, and an icicle.
